(19) United States
(12) Patent Application Publication
(10) Pub. No.: US 2026/0260191 A1
(43) Pub. Date: Sep. 3, 2026

(54) Production Planning Device, Production Planning Method, and Program

(71) Applicant: Hitachi, Ltd., Chiyoda-ku, Tokyo (JP)

(72) Inventors: Takahiro NAKANO, Tokyo (JP); Shota UMEDA, Tokyo (JP)

(21) Appl. No.: 18/865,181

(22) PCT Filed: Mar. 24, 2023
(86) PCT No.: PCT/JP2023/011686

§ 371 Date: Nov. 12, 2024

(30) Foreign Application Priority Data
May 18, 2022 (JP) 2022-081717

(51) Int. Cl. G06Q 10/0631; G05B 19/409

(52) U.S. Cl. CPC G06Q 10/06313; G05B 19/409; G05B 2219/42058

(57) ABSTRACT

The present invention makes it possible to generate a production plan that makes it possible both to attain an objective related to productivity and to nurture the proficiency of an operator.

The present invention is provided with: a proficiency predictive model generation unit that generates proficiency predictive model information predicting variation in the proficiency of an operator related to productivity based on a work record of the operator who performs an operation process related to manufacture of a product; and a plan generation unit that, using the proficiency predictive model information, predicts variation in proficiency according to a result of allocation of an operation process to the operator and generates a production plan in which the operation process and a schedule of work implementation are allocated to the operator so that the proficiency of the operator is nurtured.

### TECHNICAL FIELD

The present invention relates to a production planning device, a production planning method, and a program. The present invention claims the priority of Japanese Patent Application No. 2022-081717 filed on May 18, 2022 and in designated states where incorporation by reference to a document is approved, the contents described in the application are incorporated in the present application by reference.

### BACKGROUND ART

A conventional production scheduler makes a production plan using a standard operation time prescribed for each process of a product. However, since an operation time differs according to the proficiency of an operator, variation from operator to operator is produced in an operation time relative to the standard operation time. For this reason, a deviation from a work plan is produced in each operator and a problem results: production cannot be implemented as initially planned.

In addition, a conventional production scheduler does not have a production planning function with an operator's proficiency taken into account; therefore, a site manager allocates operation to each operator based on the manager's own evaluation so as to secure operation quality. For this reason, the evaluation of proficiency is not quantified and the evaluation of each operator varies depending on a site manager; therefore, when operation is not appropriately allocated to each operator, a problem of a defective being produced in a product arises.

Further, a site manager manually generates a nurturing plan for nurturing the proficiency of each operator and reduction of generation man-hours also poses a problem.

Patent Literature 1 discloses a technology for generating a production plan by performing a production process simulation using a standard operation time in result data of a similar product produced in the past, proficiency transition data indicating variation in preset proficiency with time obtained when an operator is engaged in some operation, and the like.

Specifically, with respect to a production process assisting method, the literature describes, “a product similar to the new product is selected from the result data of each product produced in a target production process in the past; prediction data of a standard operation time, standard operation man-hours, an operation difficulty level and member procurement timing of the new product, a fatigue level of an operator, and the proficiency of an operator is computed based on the result data; a production process of the new product is simulated in advance by a production process simulation based on the prediction data; and a production plan is generated based on a result of the simulation”.

### CITATION LIST

### Patent Literature

Patent Literature 1: Japanese Unexamined Patent Application Publication No. 2007-133664

### SUMMARY OF INVENTION

### Technical Problem

As mentioned above, in the technology in Patent Literature 1, a production plan is generated based on a preparatory simulation with result data of a past similar product, the proficiency of each operator, and the like taken into account. However, when a production plan is generated, the technology in the above literature does not take nurturing the proficiency of an operator into account.

For this reason, even when the technology in Patent Literature 1 is used, it is difficult to generate a production plan that enables objectives of production efficiency and yield to be attained and at the same time, the proficiency of an operator to be nurtured.

The present invention has been made in consideration of the above problems and it is an object of the present invention to generate a production plan that makes it possible both to attain an objective related to productivity and to nurture the proficiency of an operator.

### Solution to Problem

The present application includes a plurality of means for solving at least some of the above problems and an example of the means is as follows: A production planning device according to an aspect of the present invention to solve the above problems includes: a proficiency predictive model generation unit that generates proficiency predictive model information predicting variation in the proficiency of an operator related to productivity based on a work record of the operator who performs an operation process related to manufacture of a product; and a plan generation unit that, using the proficiency predictive model information, predicts variation in proficiency according to a result of allocation of an operation process to the operator and generates a production plan in which the operation process and a schedule of work implementation are allocated to the operator so that the proficiency of the operator is nurtured.

### Advantageous Effects of Invention

According to the present invention, a production plan that makes it possible both to attain an objective related to productivity and to nurture the proficiency of an operator can be generated.

### BRIEF DESCRIPTION OF DRAWINGS

FIG. 1 is a drawing illustrating an example of a general configuration of a production planning device.

FIG. 2 is a drawing illustrating an example of work record information.

FIG. 3 is a graph diagram showing a relation between the proficiency of productivity based on proficiency predictive model information and a work feature.

FIG. 4 is a drawing illustrating an example of proficiency nurturing plan information.

FIG. 5 is a drawing illustrating an example of production volume information.

FIG. 6 is a drawing illustrating an example of process plan candidate information.

FIG. 7 is a drawing illustrating an example of production plan information.

FIG. 8 is a drawing showing a gap between proficiency at present and an objective value of proficiency.

FIG. 9 is a flowchart showing an example of production plan generation processing.

FIG. 10 is a drawing showing an example of generation processing for a production plan with an operator nurturing plan taken into account.

FIG. 11 is a drawing illustrating an example of a screen showing information indicating predicted variation in proficiency.

FIG. 12 is a drawing illustrating an example of a hardware configuration of a production planning device.

### DESCRIPTION OF EMBODIMENTS

Hereafter, a description will be given to an embodiment of the present invention with reference to the drawings.

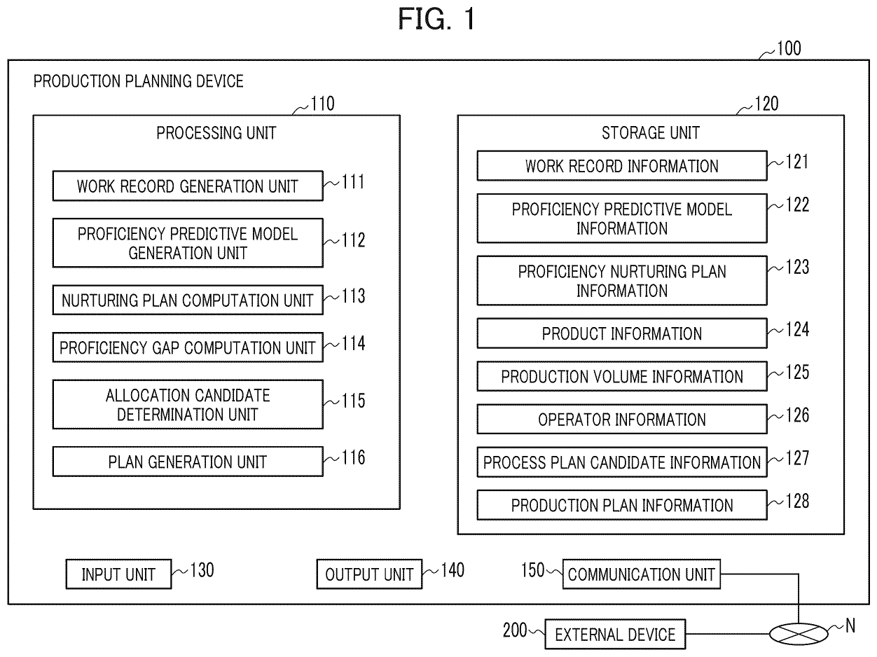

FIG. 1 is a drawing illustrating an example of a general configuration of a production planning device 100 according to the present embodiment. The production planning device 100 is a device that generates proficiency predictive model information outputting a predictive value of the proficiency of an operator, such as production efficiency (production throughput) and a yield rate and, using the proficiency predictive model information, generates a production plan so as to minimize a gap between the proficiency of an operator in an operation process for a product at present and objective proficiency. According to such a production planning device 100, a nurturing plan for an operator is taken into account and further, an optimum production plan is generated.

As shown in the drawing, the production planning device 100 includes a processing unit 110, a storage unit 120, an input unit 130, an output unit 140, and a communication unit 150.

First, a description will be given to the storage unit 120. The storage unit 120 is a functional part that stores varied information used in processing performed at the production planning device 100. The storage unit 120 stores also information generated at the production planning device 100.

Specifically, the storage unit 120 holds work record information 121, proficiency predictive model information 122, proficiency nurturing plan information 123, product information 124, production volume information 125, operator information 126, process plan candidate information 127, and production plan information 128.

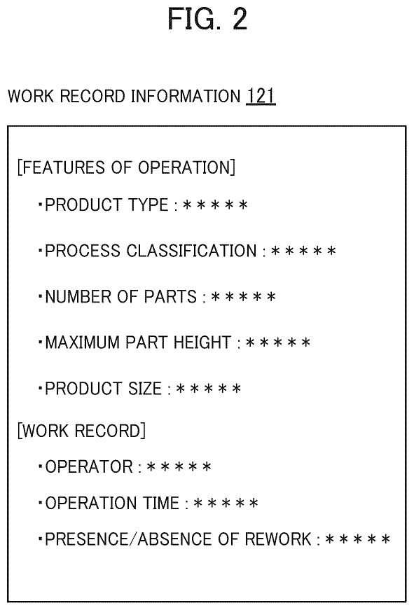

FIG. 2 is a drawing illustrating an example of work record information 121. The work record information 121 contains varied information related to the work record of each operator. Specifically, the work record information 121 contains, as features of operation, product type, process classification, number of parts, maximum part height, and product size. The product type is information identifying a product type of a product and, for example, a product ID is registered. The process classification is information identifying the contents of an operation process and, for example, a process ID is registered. For number of parts, a number of parts constituting a product is registered. For product size, information indicating a size of a product is registered.

For work record information 121, as work record, an operator, an operation time, and the presence/absence of rework are registered. For operator, an operator ID identifying an operator is registered. For operation time, a time taken in work identified by process classification is registered. For presence/absence of rework, information indicating whether rework took place when work identified by process classification was performed is registered.

Work record information 121 is used to generate proficiency predictive model information 122 predicting the proficiency of each operator.

Proficiency predictive model information 122 is an information model used to quantitatively evaluate the proficiency of productivity, such as the production efficiency and yield rate of an operator and predict how proficiency varies according to an operation process performed by an operator. Proficiency predictive model information 122 is generated for each operator.

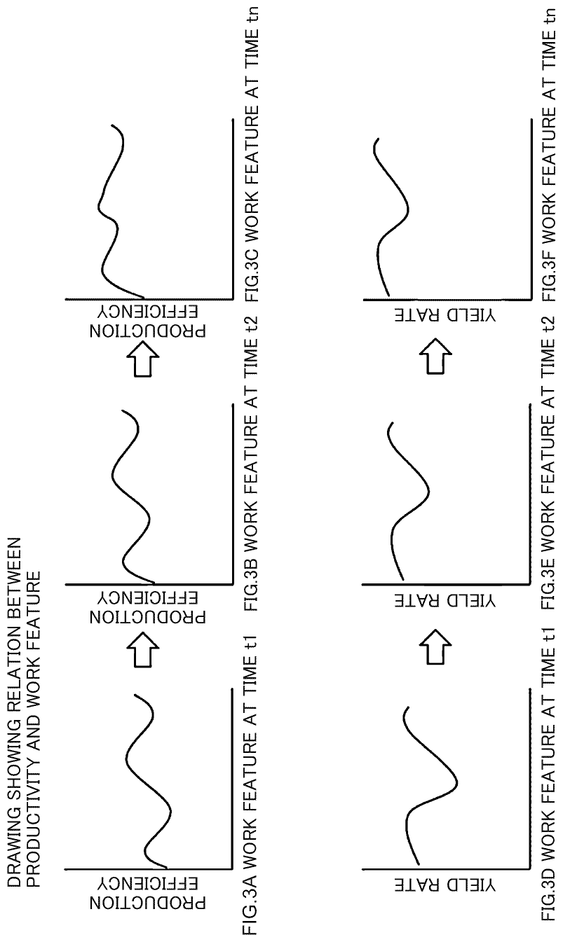

FIG. 3 is a graph diagram showing a relation between the proficiency of productivity based on proficiency predictive model information 122 and a work feature.

Specifically, FIG. 3(a) to 3(c) are examples in which variation in proficiency of the production efficiency of some operator is represented in chronological order. FIG. 3(d) to 3(f) are examples in which variation in proficiency of the yield rate of the relevant operator is represented in chronological order.

In FIG. 3(a) to 3(f), the horizontal axes indicate work features. The work features represent multidimensional features (parameters), such as product type, process classification, number of parts, maximum part height, and product size, indicating the features of a product and an operation process in which an operator is engaged in, as two-dimensional features by dimensionality reduction. For this reason, the width in the horizontal axis direction is in proportion to numbers of the product types of products worked by an operator or types of operation process.

In FIG. 3(a) to 3(c), the vertical axes indicate the proficiency of production efficiency. The production efficiency is in proportion to the height of production throughput per unit operation time. That is, using these graph diagrams indicating a relation between production efficiency and work feature, an operation time for performing an operation process of a process classification indicated by the relevant work feature can be computed from a value of production efficiency corresponding to some work feature. In FIG. 3(d) to 3(f), the vertical axes indicate the proficiency of yield rate. The yield rate is in proportion to a number of work records that do not involve an occurrence of rework. That is, using these graph diagrams indicating a relation between yield rate and work feature, a yield rate obtained when an operation process of process classification indicated by the relevant work feature is performed can be computed from a value of yield rate corresponding to some work feature.

These graphs indicating a relation between proficiency related to productivity and work feature can be generated by inputting various parameters (product type, work classification, number of parts, maximum part height, product size, operation time, presence/absence of rework registered in work record information 121) in work record information 121 at the time of generation (present time) into proficiency predictive model information 122.

FIG. 3(a) and 3(d) represent a relation between the proficiency of an operator at the present time t1 and a work feature. When various parameters in work record information 121 generated according to work performed after time t1 are inputted into the relevant model information, a graph indicating a relation between the proficiency related to productivity of an operator at each point in time (t2, tn, or the like) and a work feature is generated according to the contents of the relevant work record.

The graphs in FIG. 3 are an example, a relation between proficiency and work feature is not limited to this. For example, a work feature may contain a parameter (for example, operator ID and the like) related to an operator.

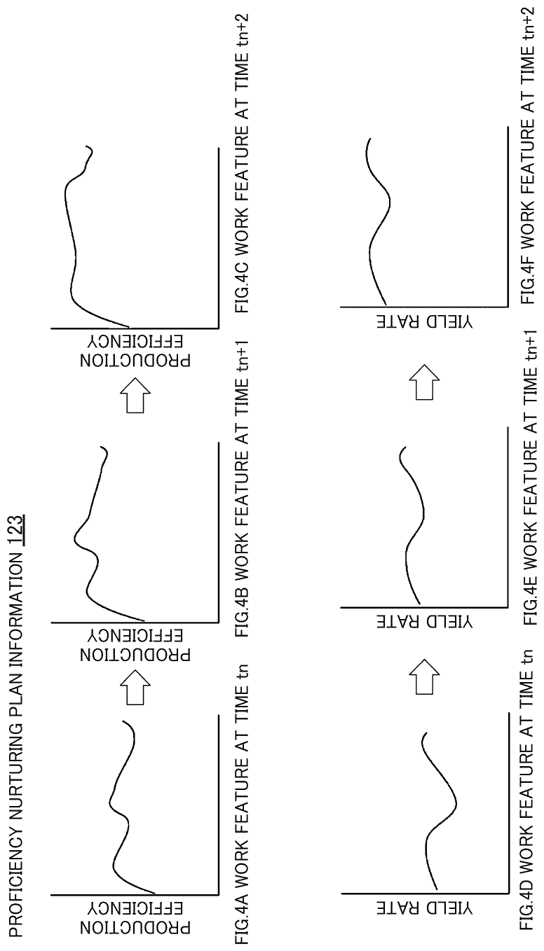

FIG. 4 is a drawing illustrating an example of proficiency nurturing plan information 123. As shown in the drawing, a proficiency nurturing plan is expressed by a graph indicating a relation between an objective value of proficiency, such as production efficiency and yield rate, related to productivity of each operator at each point in time (for example, tn, tn+1, tn+2, and the like) ahead (future) of the present point in time (for example, t1) and a work feature.

FIG. 4(a) to 4(c) are examples representing a nurturing plan related to production efficiency of some operator in chronological order. FIG. 4(d) to 4(f) are example representing a nurturing plan related to yield rate of some operator in chronological order. Each of the work feature on the horizontal axes and the production efficiency or yield rate on the vertical axes is defined as in FIG. 3; therefore, a detailed description thereof is omitted.

Such proficiency nurturing plan information 123 is computed by inputting an objective value of proficiency related to productivity into proficiency predictive model information 122 corresponding to each operator. Specifically, the proficiency nurturing plan information is generated by a site manager inputting, as an objective value for each operator, an objective operation time or an objective yield rate at each point in time (for example, each future point in time tn+1, tn+2, and the like by one to three month unit) at each point in time ahead (future) of the present point in time (for example, t1) into proficiency predictive model information 122 in set with parameters of work features, such as product type and operation process. A value of production efficiency is in proportion to the height of production throughput per unit time; therefore, production efficiency is computed by inputting an objective operation time into proficiency predictive model information 122 in correspondence with product type and operation process.

The description will be back to FIG. 1. For product information 124, information related to various products is registered. Specifically, for product information 124, for example, varied information corresponding to information registered for work record information 121 is registered, including product ID, component, number of parts, maximum part height, product size and a production process performed to manufacture the relevant product.

Such product information 124 is used to generate work record information 121 corresponding to an operation performed by an operator.

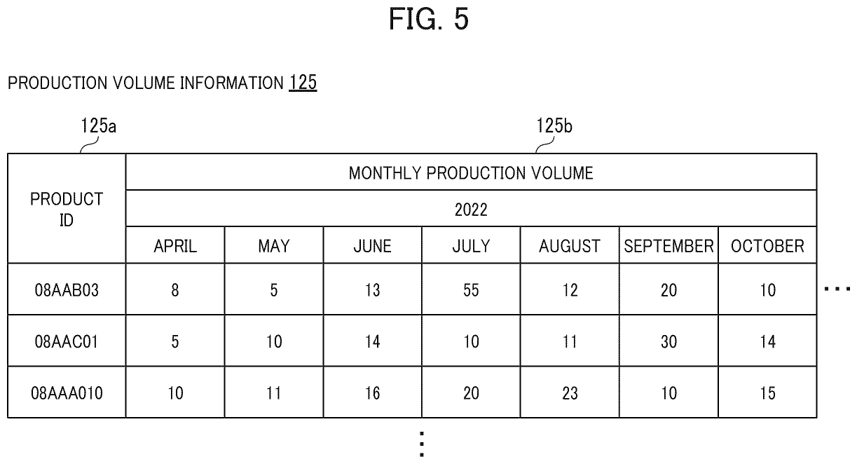

FIG. 5 is a drawing illustrating an example of production volume information 125. Production volume information 125 is information indicating a planned production quantity of a product for each period. Specifically, a product ID 125a in production volume information 125 is information for identifying a produced product. A monthly production volume 125b is information indicating a planned production quantity of a target product in a predetermined target period.

Production volume information 125 is referred to, for example, when a site manager sets an objective value related to the proficiency of each operator. A site manager refers to production volume information 125 and thereby sets an objective value of the proficiency related to productivity of each operator before a predetermined time. Specifically, a site manager uses a planned production volume of a product as reference to set an objective value of the proficiency of each operator at each point in time, inputs the relevant objective value into proficiency predictive model information 122 and thereby, computes proficiency nurturing plan information 123 of each operator. Production volume information 125 is used in production plan generation processing described later.

The description will be back to FIG. 1. Operator information 126 contains varied information related to an operator. Specifically, for operator information 126, varied information, such as an operator ID for identifying an operator, scheduled work date, and work record, is registered.

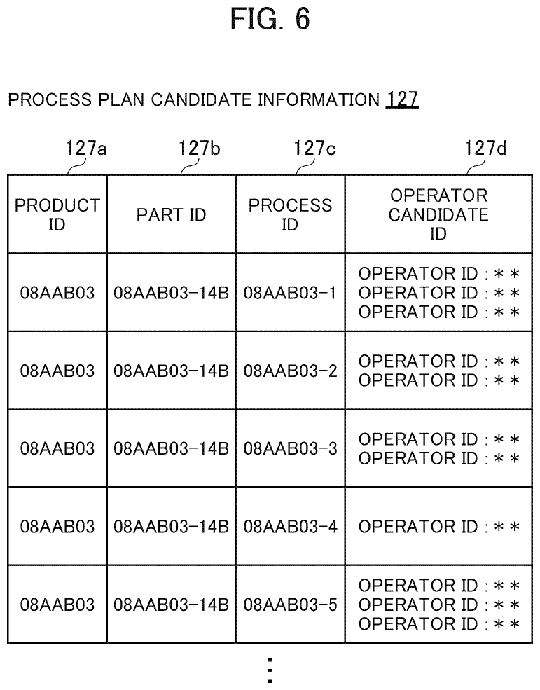

FIG. 6 is a drawing illustrating an example of process plan candidate information 127. Process plan candidate information 127 is information in which an operator candidate who can perform each work is allocated to each operation process according to proficiency related to productivity and is registered. Specifically, a product ID 127a in process plan candidate information 127 is information for identifying a product to be manufactured. A part ID 127b is information for identifying a part constituting a product. A process ID 127c is information for identifying each process. An operator candidate ID 127d is information for identifying an operator candidate having proficiency with which an operation of a process ID 127c in correspondence therewith can be performed. For operator candidate ID 127d, at least one operator candidate is brought into correspondence with one process ID and is registered.

Such process plan candidate information 127 is generated by production plan generation processing, described later, is performed. After execution of production plan generation processing, an operator identified by a generated production plan is assigned to an operator candidate ID 127d in process plan candidate information 127 and the process plan candidate information is updated to process plan information.

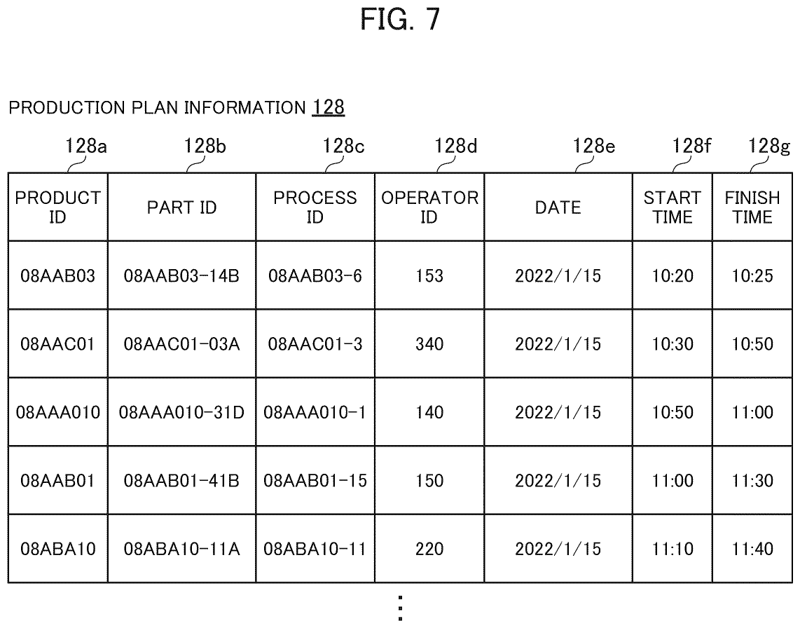

FIG. 7 is a drawing illustrating an example of production plan information 128. For production plan information 128, for example, information indicating production timing of a product is registered, including date on which each process for product manufacture is performed, start time, and finish time. Specifically, a product ID 128a in production plan information 128 is information for identifying a product to be manufactured. A part ID 128b is information for identifying a part constituting a product. A process ID 128c is information for identifying a process. An operator ID 128d is information for identifying an operator who does the contents of work of a process ID 128c in correspondence therewith. A date and time 128e is information indicating, for example, date and time of execution of a predetermined process to assemble a part of a corresponding part ID 128b in manufacture of a product identified by a product ID 128a in correspondence therewith. A planned start time 128f is information indicating a planned time of start of a process identified by a process ID 128c in correspondence therewith. A planned finish time 128g is information indicating a planned time of finish of the relevant process.

Production plan information 128 is generated when production plan generation processing, described later, is performed.

Subsequently, a description will be given to the processing unit 110. The processing unit 110 is a functional part that performs varied processing executed at the production planning device 100. As shown in FIG. 1, the processing unit 110 includes a work record generation unit 111, a proficiency predictive model generation unit 112, a nurturing plan computation unit 113, a proficiency gap computation unit 114, an allocation candidate determination unit 115, and a plan generation unit 116.

The work record generation unit 111 is a functional part that generates work record information 121. Specifically, when each operator performs an operation process allocated thereto, the work record generation unit 111 generates work record information 121 containing the contents of the performed operation using product information 124 and operator information 126.

The proficiency predictive model generation unit 112 is a functional part that generates proficiency predictive model information 122. Specifically, using work record information 121, the proficiency predictive model generation unit 112 generates proficiency predictive model information 122 for predicting how the proficiency of an operator related to productivity chronologically varies by techniques of machine learning and statistical analysis. No special limit is imposed on a technique to generate proficiency predictive model information 122 and a publicly known technology can be used, including, for example, deep learning (especially, LSTM: Long Short Term Memory) using multivariable time series data as input, a regression technique that uses an explanatory variable, including information related to time, as input and predicts an object variable (production efficiency, yield rate), and the like.

The nurturing plan computation unit 113 is a functional part that computes proficiency nurturing plan information 123. Specifically, the nurturing plan computation unit 113 inputs an objective value of each operator acquired through the input unit 130 into proficiency predictive model information 122 and thereby computes proficiency nurturing plan information 123 in which the proficiency of each operator related to productivity at each point in time (for example, points in time tn, tn+1, tn+2, and the like) in a nurturing plan is indicated by graph.

More specifically, through the input unit 130, the nurturing plan computation unit 113 acquires: date indicating each point in time (for example, each future point in time tn, tn+1, tn+2, and the like by one to three month unit) ahead (future) of the present point in time (for example, t1) ; a product type and an operation process, and an objective operation time and an objective yield rate of each operator corresponding thereto. Further, the nurturing plan computation unit 113 inputs these acquired pieces of information into proficiency predictive model information 122 and thereby computes proficiency nurturing plan information 123 in which the proficiency of each operator related to productivity at each point in time (for example, tn, tn+1, tn+2, and the like) in a nurturing plan is indicated by graph.

The proficiency gap computation unit 114 is a functional part that computes a width of deviation (gap) between proficiency related to productivity at the present point in time and objective proficiency. Specifically, using proficiency predictive model information 122, the proficiency gap computation unit 114 generates graphs indicating the proficiency of an operator related to productivity at the present point in time and objective proficiency related to the relevant productivity and compares these graphs with each other to compute a gap therebetween. For objective proficiency, information computed by the nurturing plan computation unit 113 can be used.

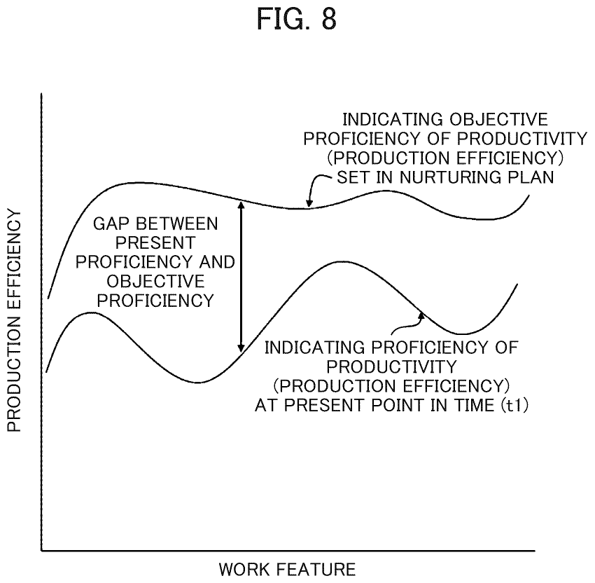

FIG. 8 is a drawing showing a gap between proficiency at the present point in time and objective proficiency. As shown in the drawing, a gap is present between proficiency related to productivity (the example shown in the drawing shows a case of production efficiency but yield rate may be adopted instead) at the present point in time and objective proficiency set by a site manager. The proficiency gap computation unit 114 identifies a gap as a difference between such proficiencies. The proficiency gap computation unit 114 may compute a magnitude of a gap therebetween in some work feature or may compute an average value of differences therebetween in each work feature as a gap.

Such gap in proficiency is used to generate a production plan with a nurturing plan taken into account. By generating a production plan in which an operation process is allocated to each operator so that the magnitude of the relevant gap is made smallest (minimized), as described later, a production plan with a nurturing plan taken into account can be made, in which production plan, objective proficiency is attained after a predetermined period.

The allocation candidate determination unit 115 is a functional part that determines an operator to whom each operation process can be allocated according to the proficiency of the operator as an operator candidate. Specifically, the allocation candidate determination unit 115 determines, for example, a type and a quantity (volume) of a product to be produced from production volume information 125. Further, the allocation candidate determination unit 115 determines an operation process required to manufacture a product using product information 124. In addition, the allocation candidate determination unit 115 computes an operation time set (allowed) for each operation process of the relevant product based on a manufacturing period determined from production volume information 125. Furthermore, the allocation candidate determination unit 115 determines a lower limit value of yield rate preset for each product from predetermined set information (not shown) stored in the storage unit 120.

The allocation candidate determination unit 115 determines an operator who has proficiency satisfying a computed operation time and a determined yield rate based on an operation time and yield rate determined from a graph (for example, the graphs in FIG. 3) of proficiency obtained by inputting work record information 121 at the present point in time into proficiency predictive model information 122. The allocation candidate determination unit 115 generates process plan candidate information 127 in which at least one operator candidate is brought into correspondence with each process ID.

The plan generation unit 116 is a functional part that generates varied plan information. Specifically, the plan generation unit 116 performs production plan generation processing and thereby generates production plan information 128 with an operator nurturing plan taken into account.

Up to this point, the description has been given to the processing unit 110.

The input unit 130 is a functional part that accepts input of an instruction or information from a user (operator) of the production planning device 100 through an input device provided in the production planning device 100. Further, the input unit 130 accepts input of an instruction or information from an external device 200 through the communication unit 150.

The output unit 140 is a functional part that generates output information (including display information) and displays the display information on an output device (for example, a display) provided in the production planning device 100 or the external device 200.

The communication unit 150 is a functional part that communicates information with the external device 200. Specifically, the communication unit 150 sends and receives varied information to and from the external device 200 through a network (communication line network) N, such as the Internet or LAN (Local Area Network).

Up to this point, a description has been given to an example of a general configuration (functional blocks) of the production planning device 100.

### Description of Operation

Subsequently, a description will be given to production plan generation processing performed at the production planning device 100.

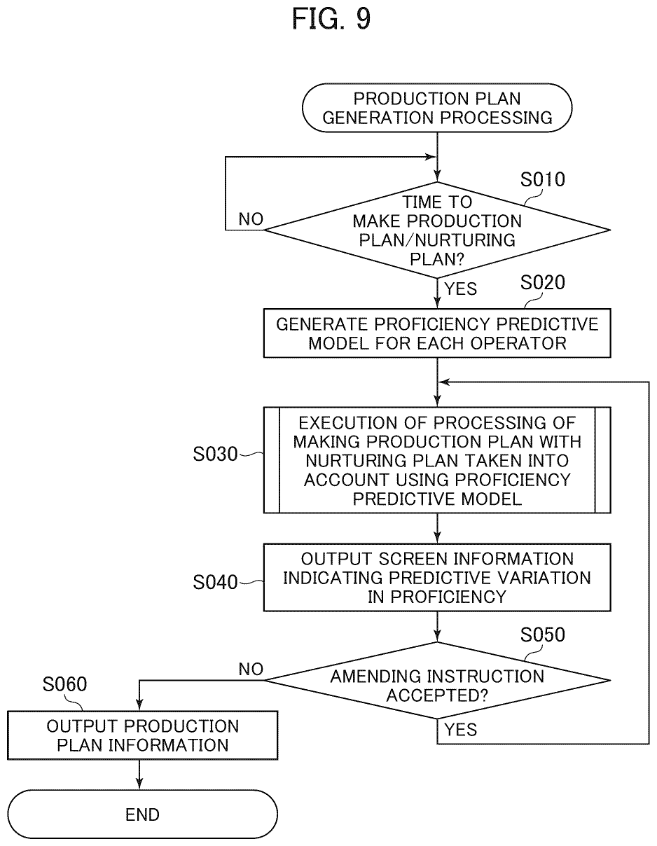

FIG. 9 is a flowchart illustrating an example of production plan generation processing. The production plan generation processing is processing in which production plan information 128 is generated so that a gap between the proficiency of an operator related to productivity at the present point in time and objective proficiency is made smallest (minimized) and optimum production plan information 128 with an operator nurturing plan taken into account is thereby generated (made).

Production plan generation processing is initiated, for example, when the production planning device 100 is started.

When processing is initiated, the plan generation unit 116 determines whether it is time to make a production plan and a nurturing plan (Step S010). Specifically, the plan generation unit 116 determines whether it is equivalent to time to make a preset weekly or monthly production plan or nurturing plan.

When it is determined that it is time to make a plan (Yes at Step S010), the plan generation unit 116 makes a transition to Step S020. Meanwhile, when it is determined that it is not time to make a plan (No at Step S010), the plan generation unit 116 performs the processing of Step S010 again.

At Step S020, the proficiency predictive model generation unit 112 generates proficiency predictive model information 122 at the present point in time of each operator. Specifically, the proficiency predictive model generation unit 112 identifies the operator ID of each operator using operator information 126. Using work record information 121 for which the relevant operator ID is registered, the proficiency predictive model generation unit 112 generates proficiency predictive model information 122 of each operator, for example, by such a predetermined technique as regression analysis.

Subsequently, the plan generation unit 116 performs the processing of making a production plan with an operator nurturing plan taken into account, using the generated proficiency predictive model information 122 (Step S030).

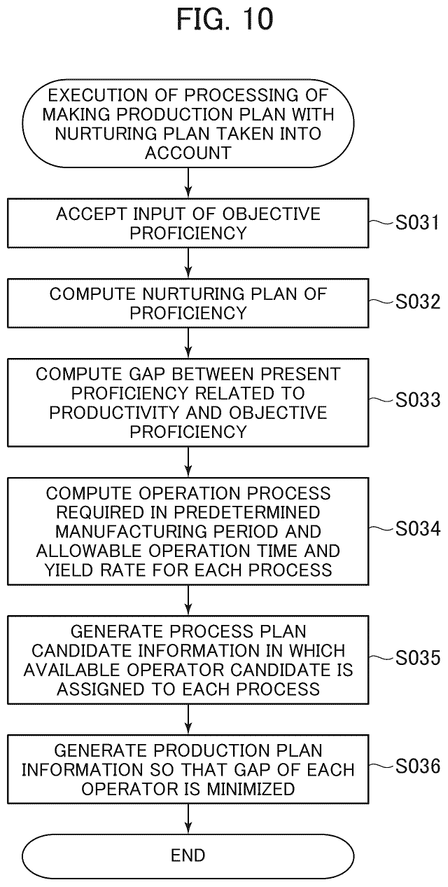

FIG. 10 is a drawing illustrating an example of processing of making a production plan with an operator nurturing plan taken into account. First, the nurturing plan computation unit 113 accepts input of objective proficiency (Step S031). Specifically, the nurturing plan computation unit 113 displays screen information for accepting input of an objective value on the output device (display) through the output unit 140. Further, through the input unit 130, the nurturing plan computation unit 113 accepts of input of: date at each point in time (for example, date indicating each future point in time by one to three month unit) in a nurturing plan, an operator ID, a product type and an operation process, and an objective value (for example, an objective operation time and an objective yield rate) for the relevant product type and operation process.

Subsequently, the nurturing plan computation unit 113 computes a nurturing plan of proficiency (Step S032). Specifically, the nurturing plan computation unit 113 inputs accepted information related to an objective value into the proficiency predictive model information 122 of the corresponding operator and thereby computes proficiency nurturing plan information 123 in which proficiency related to productivity at each point in time in a nurturing plan is indicated.

Subsequently, the proficiency gap computation unit 114 computes a gap between proficiency related to productivity at the present point in time and objective proficiency (Step S033). Specifically, the proficiency gap computation unit 114 compares a graph of the proficiency of an operator related to productivity at the present point in time, generated using proficiency predictive model information 122, and a graph indicating objective proficiency at a predetermined point in time, shown by proficiency nurturing plan information 123, with each other and thereby computes a gap therebetween.

The proficiency gap computation unit 114 may computes a gap between a gap of proficiency corresponding to some work feature (for example, a work feature corresponding to a product type and an operation process accepted as an objective value from a site manager) and proficiency at the present point in time or may compute an average value of differences therebetween in each work feature as a gap.

Subsequently, the allocation candidate determination unit 115 computes an operation process required in a predetermined manufacturing period and an operation time and a yield rate set (allowed) for each process (Step S034). Specifically, the allocation candidate determination unit 115 determines a type and a quantity (volume) of a product to be produced during a manufacturing period determined from, for example, production volume information 125 and determines operation processes required for the manufacture of the relevant product and a number thereof using product information 124. The allocation candidate determination unit 115 computes an operation time set for each operation process of the relevant product based on the relevant manufacturing period. Further, the allocation candidate determination unit 115 determines a lower limit value of yield rate preset for each product from the storage unit 120.

Subsequently, the allocation candidate determination unit 115 generates process plan candidate information 127 in which an available operator candidate is assigned to each operation process (Step S035). Specifically, the allocation candidate determination unit 115 determines an operator whose proficiency satisfies the computed operation time and the determined yield rate from a graph (a graph indicating a relation between proficiency related to productivity, such as production efficiency, and work feature) generated using proficiency predictive model information 122, and generates process plan candidate information 127 in which the operator is brought into correspondence with each process ID 127c as an operator candidate.

Subsequently, the plan generation unit 116 generates production plan information 128 so that the gap of each operator is minimized (Step S036). Specifically, using process plan candidate information 127, the plan generation unit 116 makes an initial allocation in which an operation process is allocated to an operator candidate (in cases where a plurality of operator candidates is in correspondence with one operation process, an arbitrary operator candidate).

Further, the plan generation unit 116 generates work record predictive information indicating a work record obtained when an operation process allocated to each operator candidate is performed before some point in time in a nurturing plan. Specifically, the plan generation unit 116 determines a feature (product type, process classification, number of parts, and the like) of an operation process allocated to each operator candidate using product information 124, and generates the relevant work feature and predictive information of work record, including a predictive operation time and the presence/absence of rework, predicted by statistical analysis using the past work record information 121 of each operator candidate. Work record predictive information contains the same items as those in work record information 121.

Further, the plan generation unit 116 inputs work record predictive information into proficiency predictive model information 122 and thereby acquires a prediction graph (for example, graphs shown in FIG. 3) indicating chronological variation in proficiency related to productivity. The plan generation unit 116 computes a predictive gap in initial allocation based on a difference between a prediction graph indicating proficiency obtained when an initially allocated operation process is performed and a graph indicating objective proficiency. The plan generation unit 116 subtracts the predictive gap in initial allocation from the gap computed at Step S033 and thereby determines a reduced width of the gap of each operator candidate.

The plan generation unit 116 repeatedly performs a simulation in which while changing an operator candidate to whom an operation process is allocated, a predictive gap of each operator candidate is computed and the above-mentioned reduced width of gap is determined. The plan generation unit 116 determines a combination of an operation process larger in determined reduced width and an operator candidate to whom the relevant operation process is allocated.

As a result of a combination of an operation process and an operator candidate to whom the relevant operation process is allocated being determined as mentioned above, a combination in which a gap between proficiency at the present point in time and objective proficiency is minimized, that is, a combination of an operation process that brings proficiency at the present point in time closer to objective proficiency and an operator candidate to whom the relevant operation process is allocated is determined.

As a technique to determine an optimum combination by a simulation as mentioned above, for example, such a publicly known optimization technique as metaheuristics method can be adopted.

The plan generation unit 116 generates process plan information in which an operator candidate in a determined combination is assigned to the relevant operation process.

Using production volume information 125, operator information 126, and process plan information, the plan generation unit 116 computes date and time on which an operation process is performed and generates production plan information 128 containing the execution timing of each operation process. As a method for generating a production plan using a process plan, a publicly known technology can be adopted.

After generating production plan information 128, the plan generation unit 116 terminates this flow and causes the processing to proceed to Step S040 in FIG. 9.

The processing of Step S031 to Step S036 may be performed, for example, by each group of operators deployed in advance in each production line of a plant.

At Step S040, the output unit 140 outputs screen information indicating predictive variation in the proficiency of productivity.

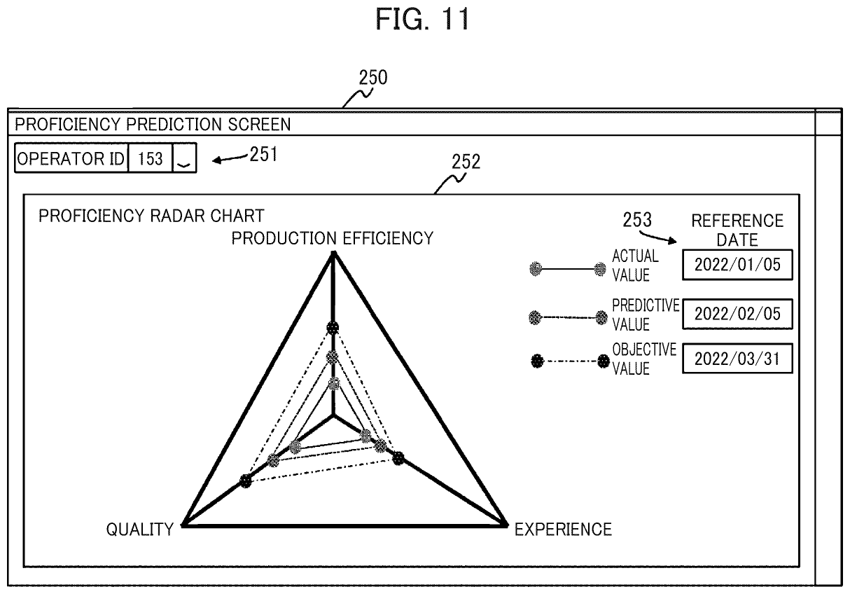

FIG. 11 is a drawing illustrating a screen example 250 in which information indicating predictive variation in proficiency is displayed. The screen example 250 in this example displays an operator selecting field 251 selectably displaying a target operator and a radar chart display field 252 displaying a radar chart of proficiency.

A radar chart of proficiency displayed in the radar chart display field 252 shows predictive variation in the proficiency related to productivity of an operator selected in the operator selecting field 251. Specifically, a radar chart includes the following items: production efficiency, quality, and experience. Further, in a radar chart, graphs of an actual value, a predictive value, and an objective value on each reference date 253 are formed.

The graph of actual value indicates proficiency on reference date (in the example shown, 2022 Jan. 5, for example, the present point in time) of actual value. The graph of actual value is generated based on a graph (for example, the graph in FIG. 3(a)) obtained by inputting work record information 121 of an operator generated before reference date of actual value into proficiency predictive model information 122. Specifically, the graph scale of production efficiency is equivalent, for example, to an average value of production efficiency on the vertical axis in FIG. 3(a). The graph scale of quality is equivalent, for example, to an average value of yield rate on the vertical axis in FIG. 3(d). Experience is equivalent to an amount of work record information 121 generated before reference date, that is, a quantity of workload performed by a selected operator.

The graph of predictive value indicates proficiency predicted on reference date (in the example shown, 2022 Feb. 5) of predictive value. Specifically, each item scale of the graph of predictive value are computed, for example, based on production efficiency, yield rate and work record information 121 (including work record predictive information) at a first point in time (for example, point in time of tn in FIG. 4(a), 4(d) or point in time of tn+1 FIG. 4(b), 4(e)) in proficiency nurturing plan information 123.

The graph of objective value indicates objective proficiency predicted on reference date (in the example shown, 2022 Mar. 31) of objective value. Specifically, each item scale of the graph of objective value are computed, for example, based on production efficiency, yield rate, and work record information 121 (including work record predictive information) at a second point in time (for example, point in time of tn+2 in FIG. 4(c), 4(f)) in nurturing plan information.

The description will be back to FIG. 9. Subsequently, the input unit 130 determines whether an amending instruction has been accepted (Step S050). Specifically, the input unit 130 determines whether an amending instruction has been accepted, for example, from a site manager or the like through a predetermined amending instruction accepting screen displayed on the output device by the output unit 140. Examples of the amending instructions include an instruction to change an objective value of an operator, an instruction to change an operation process allocated to an operator, and the like.

When it is determined that an amending instruction has been accepted (Yes at Step S050), the input unit 130 causes the processing to proceed to Step S030. At Step S030, processing of making a production plan is performed again with the amending instruction reflected therein.

Meanwhile, when it is determined that an amending instruction has not been accepted (No at Step S050), the output unit 140 outputs generated production plan information 128 to the output device (Step S060) and terminates this flow.

Up to this point, the description has been given to production plan generation processing.

According to such a production planning device 100, a production plan that enables an objective related to productivity to be attained and at the same time, the proficiency of an operator to be nurtured can be generated. That is, the production planning device 100 is capable of making a production plan in which KPI (Key Performance Indicator) related to nurturing indicated by a gap between the present proficiency and objective proficiency and KPI related to productivity, such as production efficiency and yield rate, are simultaneously optimized. KPI related to productivity may include, for example, deadline compliance rate. Like KPI of production efficiency and the like, KPI of deadline compliance rate can also be computed by performing production plan generation processing, for example, based on graph diagrams plotted using work record information of an operator and proficiency predictive model information.

The production planning device 100 is capable of predicting variation in the proficiency of an operator by generating proficiency predictive model information related to productivity of each operator. For this reason, the production planning device 100 is capable of computing a nurturing plan corresponding to the characteristics of each operator for attaining objective proficiency.

The production planning device 100 is capable of computing a gap as a difference between the present proficiency and the objective proficiency of each operator and generating a process plan and a production plan in which an operation process is allocated to an appropriate operator so as to make smallest (minimize) the relevant gap. For this reason, the production planning device 100 is capable of making a production plan with nurturing of each operator taken into account.

The production planning device 100 computes an operation time and a yield rate of each operator using proficiency predictive model information and determines, as an operator candidate, an operator having proficiency satisfying an operation time and a yield rate required in an operation process for a product. For this reason, the production planning device 100 is capable of making a production plan in which an operator involving a less risk of occurrence of delay in product manufacture or quality defect can be selected and further the relevant operator can be nurtured.

The present invention is not limited to the above-mentioned embodiment and can be variously modified. For example, when a predetermined production change incident occurs, a production planning device 100 according to a first modification makes a production plan again.

Specifically, at Step S010 of production plan generation processing, the plan generation unit 116 determines also whether a production change incident has occurred, including absence or lateness of an operator or acceptance of an order to manufacture a product type requiring rapid countermeasures.

When it is determined that such a production change incident has occurred, the plan generation unit 116 performs the processing of Step S020 to Step S060 and generates production plan information 128 corresponding to the production change incident. For example, when a production change incident is absence or lateness of an operator, the production planning unit generates the proficiency predictive model information 122, proficiency nurturing plan information 123, and process plan candidate information 127 of operators using operator information 126 excluding that of the relevant operator, and makes production plan information 128 again using these pieces of information.

For example, when a production change incident is acceptance of an order to manufacture a product type requiring rapid countermeasures, the plan generation unit 116 makes production plan information 128 again using production volume information 125 with the relevant product type and an order quantity reflected therein.

According to such a production planning device 100 in the first modification, even when an operator is absent from work or an order to manufacture a product type requiring rapid countermeasures is accepted, production plan information 128 with an operator nurturing plan taken into account can be swiftly generated again.

A plan generation unit 116 of a production planning device 100 according to a second modification generates configuration information of a production line in which an operator suitable for an operation process performed in each production line is deployed, using process plan information or planned production plan information 128.

Specifically, the plan generation unit 116 assigns an operator to each production line based on a production process allocated to each operator and various operation processes allocated to each production line in advance, and is thereby capable of generating configuration information of a production line in which an appropriate operator is deployed.

According to such a production planning device 100, configuration information in which an operator to whom an operation process with a nurturing plan taken into account is assigned is deployed in an appropriate production line can be generated in each production line in a plant.

Up to this point, the description has been given to modifications of a production planning device 100.

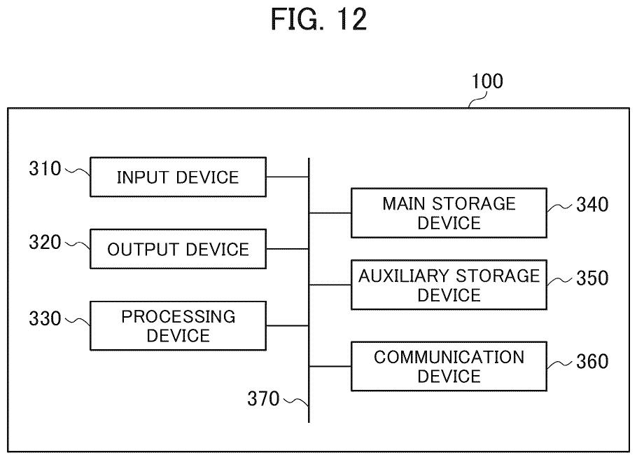

FIG. 12 is a drawing illustrating a hardware configuration of a production planning device 100. As shown in the drawing, the production planning device 100 includes an input device 310, an output device 320, a processing device 330, a main storage device 340, an auxiliary storage device 350, a communication device 360 and a bus 370 electrically connecting these elements with one another.

Examples of the input device 310 is such input devices as a touch panel, a keyboard, and a mouse. The output device 320 is such a display device as a liquid crystal display or an organic display.

An example of the processing device 330 is CPU (Central Processing Unit). The main storage device 340 is such a memory device as RAM (Random Access Memory) or ROM (Read Only Memory).

The auxiliary storage device 350 is such a nonvolatile storage device as a so-called hard disk (Hard Disk Drive) or SSD (Solid State Drive), or a flash memory capable of storing digital information.

The communication device 360 is a wired communication device that performs wired communication via a network cable or a wireless communication device that performs wireless communication via an antenna.

Up to this point, the description has been given to an example of a hardware configuration of the production planning device 100.

The processing unit 110 of such a production planning device 100 is implemented by a program that causes the processing device 330 to perform processing. This program is stored in the main storage device 340 or the auxiliary storage device 350 and is, when executed, loaded onto the main storage device 340 and executed by the processing device 330.

The input unit 130 is implemented by the input device 310. The output unit 140 is implemented by the output device 320. The storage unit 120 is implemented by the main storage device 340 or the auxiliary storage device 350 or a combination thereof. The communication unit 150 is implemented by the communication device 360.

Each of the above-mentioned configuration elements, functions, processing unit 110, processing means or the like of the production planning device 100 may be partly or wholly implemented by hardware, for example, by designing it with an integrated circuit or other like means. The above-mentioned configuration elements and functions may be implemented by software by a processor interpreting and executing a program implementing the individual functions. Information in a program, a table, a file, and the like implementing each function can be placed in such a storage device as a memory, a hard disk, SSD or the like or such a recording medium as an IC card, an SD card, DVD, or the like.

The present invention is not limited to the above-mentioned embodiment or modifications and includes various modifications without departing from the scope of the identical technical philosophy. For example, the above embodiment is described in details for making the present invention understandable and the present invention is not necessarily limited to an embodiment having all the configuration elements described above. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

In the above description, with respect to control line and information line, only those considered to be necessary for the sake of explanation are referred to and not all the control lines or information lines are referred to. Actually, it may be considered that almost all the configuration elements are connected with one another.

### LIST OF REFERENCE SIGNS

100: production planning device,
110: processing unit,
111: work record generation unit,
112: proficiency predictive model generation unit,
113: nurturing plan computation unit,
114: proficiency gap computation unit,
115: allocation candidate determination unit,
116: plan generation unit,
120: storage unit,
121: work record information,
122: proficiency predictive model information,
123: proficiency nurturing plan information,
124: product information,
125: production volume information,
126: operator information,
127: process plan candidate information,
128: production plan information,
130: input unit,
140: output unit,
150: communication unit,
200: external device,
310: input device,
320: output device,
330: processing device,
340: main storage device,
350: auxiliary storage device,
360: communication device,
370: bus,
N: network

1. A production planning device comprising:
a proficiency predictive model generation unit that, based on a work record of an operator who performs an operation process related to manufacture of a product, generates proficiency predictive model information predicting variation in the proficiency of the relevant operator related to productivity; and
a plan generation unit that, using the proficiency predictive model information, predicts variation in proficiency corresponding to a result of allocation of an operation process to the operator and generates a production plan in which the operation process and a schedule of work implementation are allocated to the operator so that the proficiency of the operator is nurtured.

2. The production planning device according to claim 1,
wherein when a production change incident caused by the operator or acceptance of a product order occurs,
the plan generation unit
generates the production plan using operator information in which the operator other than the causing operator is registered or production volume information in which a planned production quantity for each period with the causing acceptance of the product order reflected therein is registered by period.

3. The production planning device according to claim 1,
wherein the plan generation unit
generates configuration information of production lines in which the operator is deployed in each the production line, based on the operation process allocated to the operator using the proficiency predictive model information and the operation process performed in each production line for product manufacture.

4. The production planning device according to claim 1, further comprising:
a nurturing plan computation unit that, by inputting an objective operation time or an objective yield rate of the operator for the operation process into the proficiency predictive model information, computes individual objective proficiency of each operator, and
that computes a nurturing plan based on chronological variation in the objective proficiency.

5. The production planning device according to claim 1, further comprising:
an allocation candidate determination unit that determines a candidate of an operator satisfying an operation time required in an operation process related to the manufacture of the product based on an operation time obtained by inputting the work record of the operator into the proficiency predictive model information.

6. The production planning device according to claim 5,
wherein the allocation candidate determination unit
determines a candidate of an operator satisfying a yield rate required in an operation process related to the manufacture of the product based on a yield rate obtained by inputting the work record of the operator into the proficiency predictive model information.

7. The production planning device according to claim 1, further comprising:
a proficiency gap computation unit that computes a gap, which is a difference between the present proficiency obtained by inputting the work record of the operator into the proficiency predictive model information and objective proficiency obtained by inputting an objective operation time or an objective yield rate of the operator into the proficiency predictive model information.

8. The production planning device according to claim 7,
wherein the plan generation unit
generates the production plan with the gap reduced, based on a process plan in which the operation process is allocated to the operator so that the gap is reduced.

9. The production planning device according to claim 7,
wherein the plan generation unit
generates a production plan in which KPI (Key Performance Indicator) related to nurturing indicated by the gap between the present proficiency and objective proficiency of the operator and KPI related to productivity are simultaneously optimized.

10. A production planning method performed by a production planning device,
wherein the production planning device performs:
a proficiency predictive model generation step to, based on a work record of an operator who performs an operation process related to manufacture of a product, generate proficiency predictive model information predicting variation in the proficiency of the relevant operator related to productivity; and
a plan generation step to, using the proficiency predictive model information, predict variation in proficiency corresponding to a result of allocation of an operation process to the operator and generate a production plan in which the operation process and a schedule of work implementation are allocated to the operator so that the proficiency of the operator is nurtured.

11. A program causing a computer to function as a production planning device,
wherein the computer is caused to function as:
a proficiency predictive model generation unit that, based on a work record of an operator who performs an operation process related to manufacture of a product, generates proficiency predictive model information predicting variation in the proficiency of the operator related to productivity; and
a plan generation unit that, using the proficiency predictive model information, predicts variation in proficiency corresponding to a result of allocation of an operation process to the operator and generates a production plan in which the production process and a schedule of work implementation are allocated to the operator so that the proficiency of the operator is nurtured.
